(19) United States
(12) Patent Application Publication
(10) Pub. No.: US 2019/0071597 A1
(43) Pub. Date: Mar. 7, 2019

(54) COMPOSITION USEFUL IN SULFATE SCALE REMOVAL

(71) Applicant: FLUID ENERGY GROUP LTD., Calgary (CA)

(72) Inventors: Clay PURDY, Medicine Hat (CA); Markus WEISSENBERGER, Calgary (CA); Stig Magnor NORDAA, Sandnes (NO)

(21) Appl. No.: 16/119,303

(22) Filed: Aug. 31, 2018

(30) Foreign Application Priority Data
Sep. 1, 2017 (CA) 2977923

(51) Int. Cl. C09K 8/528

(52) U.S. Cl. CPC C09K 8/528; C02F 5/125

(57) ABSTRACT

The present invention discloses a novel aqueous composition for use in removing barium sulfate scale from a surface contaminated with such, said composition comprising: a chelating agent and a counterion component selected from the group consisting of: Li₅DTPA; Na₅DTPA; K₅DTPA; Cs₅DTPA; Na₄EDTA; K₄EDTA; TEAH₄DTPA; and TBAH₅DTPA; and a scale removal enhancer. There is also disclosed methods to use such compositions.

### FIELD OF THE INVENTION

The present invention is directed to a composition for use in oilfield or industrial operations, more specifically to compositions used in the removal of barium, magnesium, radium calcium and strontium sulfate scale.

### BACKGROUND OF THE INVENTION

Scaling, or the formation of mineral deposits can occur on surfaces of metal, rock or other materials. Scale is caused by a precipitation process as a result of a change in pressure and temperature and the subsequent change in the composition of a solution (commonly water).

Typical scales consist of e.g. calcium carbonate, calcium sulfate, barium sulfate, strontium sulfate, iron sulfide, iron oxides or iron carbonate.

Sometimes salt deposits restrict or even shut-off the production conduit as the produced water composition is severely affected by the change in pressure and temperature of the produced water. Not only produced formation water can cause problems, also water used in well operations can be potential sources of scale, including water used in water flood operations such as geothermal systems.

The precipitation of sulfates can occur downstream at any point in a production, injection or disposal well, and is caused by incompatibilities of injected water and formation water, changes in temperature and pressure of the produced water, wellbore additives or upsets in the flow equilibrium. Scale on surface equipment (e.g. heat exchangers, pipings) are also a main issue for sulfate scales. In offshore oil operations, seawater is often injected into reservoirs for pressure maintenance, and as seawater has a high content of sulfate ions and formation water or drilling fluids often have a high content of barium, calcium, and/or strontium ions stripped from the formation, mixing these waters causes precipitation. Sulfate scaling on surface equipment, such as heat exchangers and the associated piping, is a major issue for industry as well. Scaling challenges for industry occurs offshore and onshore. Having a sulfate dissolver that solubilizes all typical scales encountered is advantageous for industry.

The most obvious way of preventing a scale from forming during production is to prevent the creation of super saturation of the brine being handled. This may sometimes be possible by altering the operating conditions of the reservoir, for example by ensuring that the wellbore pressure is sufficient to prevent the liberation of gas and by injecting water which is compatible with formation water. However, economics usually dictate that the use of inhibitors is preferred currently as all commercially available dissolvers are inadequate for treatment schedules, until now.

Controlling scale by the use of inhibitors and understanding scaling tendencies is important for both production and injection wells.

The design of scale treatment applications requires extensive knowledge of scaling/chemistry theory and a broad base of practical experience to be successful. Applications occasionally present themselves in which the ideal selection of chemicals and fluids may be beyond the scope of a wellsite engineer's experience or theoretical knowledge. Rules of thumb and general formulas may not be adequate, and selection procedures based on broader experience and more in-depth knowledge may be required. Analysis of deposits and dissolver screening ideally when considering a potential scale dissolving application, the scale that is causing the “problems” will have to be analyzed.

The most common scales are barium, calcium, and strontium sulfate based. These alkaline earth metal salts have many similar properties and often precipitate together forming sulfate scale. The deposition of this scale is a serious problem for oil and gas producers and other industry (geothermal as an example), potentially causing fouling in the entire wellbore and surface related processing equipment. This scale not only restricts the pore size in the rock formation matrix causing formation damage, but since the water is still saturated with sulfates, the continued deposition causes fouling and potentially failing of critical equipment such as perforations, casing, tubes, valves, and surface equipment, all with the potential to reduce the rate of oil production or upset other industrial operations and result in substantial lost revenue. Sulfate scales such as radium, sulfate, barium sulfate, calcium sulfate etc.—are sometimes referred to as NORM scale due to their radioactive (coming from the radium sulfate) and solubility characteristics—typically 0.0023 g/l in water—are more difficult to deal with than carbonate scales. Sulfate scales are not soluble in traditional acid scale dissolvers. Radium sulfate, while not being the most common sulfate scale represents a challenge in its removal as it is often imbedded in barium sulfate scale and is also radioactive and thus a danger to manipulate.

Once this water insoluble scale has formed, it is extremely difficult to remove. The solubility of barium sulfate is reported to be approximately 0.0002448 g/100 mL (20° C.) and 0.000285 g/100 mL (30° C.). Existing methods to remove sulfate scale include mechanical removal and/or low performance scale dissolvers currently on the market, but both have limitations and disadvantages. Mechanical removal involves the use of milling tools, scraping, or high-pressure jetting and/or disassembly of key production equipment causing substantial down time of production and processing equipment. These methods have limited efficiency as the scale is extremely hard to remove; often forming in areas beyond the reach of the mechanical equipment as many facilities have welded joints and limited access. High pressure jetting will typically only remove the surface of the scale.

Sulfate scale dissolvers were developed to overcome the low solubility of these types of scale. Sulfate scale dissolvers work by chelating/mopping up the dissolved sulfate that is present in the water allowing more to be dissolved. To help the rate of reaction/increase the speed of dissolution these products are typically preferred to be deployed at higher temperatures of 75° C. or above. Sulfate scale dissolution will as a result take slightly longer than for example carbonate scale dissolution. Typical scale dissolvers such as ethylenediaminetetreacetic acid (EDTA), and variations of this molecule (such as DTPA) are used by the industry to dissolve sulfate scale, and sequestering the barium, calcium, and strontium ions. However, this process requires high temperatures (usually above 75° C.), is time-consuming, and has limited dissolution capacity.

The following include some patent disclosures of sulfate scale removers. U.S. Pat. No. 4,980,077 A teaches that alkaline earth metal scales, especially barium sulfate scale deposits can be removed from oilfield pipe and other tubular goods with a scale-removing composition comprising an aqueous alkaline solution having a pH of about 8 to about 14, a polyaminopolycarboxylic acid, preferably EDTA or DTPA and a catalyst or synergist comprising oxalate anion. It is stated that when the scale-removing solution is contacted with a surface containing a scale deposit, substantially more scale is dissolved at a faster rate than previously possible.

WO 1993024199 A1 teaches the use of low frequency sonic energy in the sonic frequency range for enhancing the dissolution of alkaline earth metal scales using a scale-removing solvent comprising an aqueous alkaline solution having a pH of about 8 to about 14 and containing EDTA or DTPA and a catalyst or synergist, preferably an oxalate anion. It is stated that when the scale-removing solvent is contacted with a surface containing a scale deposit while simultaneously transmitting low frequency sonic energy through the solvent, substantially more scale is dissolved at a faster rate than previously possible.

U.S. Pat. No. 4,030,548A teaches a barium sulfate scale or solid can be dissolved economically by flowing a stream of relatively dilute aqueous solution of aminopolyacetic acid salt chelating agent into contact with and along the surfaces of the scale while correlating the composition and flow rate of the solution so that each portion of solution contains an amount of chelant effective for dissolving barium sulfate and the upstream portions of the scale are contacted by portions of the solution which are unsaturated regarding the barium-chelant complex.

U.S. Pat. No. 3,625,761A teaches a method of removing a deposit of alkaline earth metal sulfate scale in an aqueous system which comprises contacting said scale deposit with a treating composition heated to a temperature in the range of from about 86 to about 194° F. consisting essentially of an aqueous alkaline solution containing from about 4 to about 8 percent by weight of disodium hydrogen ethylenediaminetetraacetate dihydrate and having a pH in the range of about 10 to 13 for a period sufficient to dissolve at least some of the said scale, acidifying said solution to decrease the pH thereof to a pH in the range of from 7 to 8 with an acid selected from the group consisting of sulfuric acid, hydrochloric acid, oxalic acid, a mixture of sulfuric acid and oxalic acid, and a mixture of hydrochloric acid and oxalic acid, to precipitate any alkaline earth metal ion present.

U.S. Pat. No. 5,084,105A teaches that alkaline earth metal scales, especially barium sulfate scale deposits can be removed from oilfield pipe and other tubular goods with a scale-removing composition comprising an aqueous alkaline solution having a pH of about 8 to about 14, preferably about 11 to 13, of a polyaminopolycarboxylic acid, preferably EDTA or DTPA and a catalyst or synergist comprising a monocarboxylic acid, preferably a substituted acetic acid such as mercaptoacetic, hydroxyacetic acid or aminoacetic acid or an aromatic acid such as salicylic acid. The description states that when the scale-removing solution is contacted with a surface containing a scale deposit, substantially more scale is dissolved at a faster rate than is possible without the synergist.

U.S. Pat. No. 7,470,330 B2 teaches a method of removing metal scale from surfaces that includes contacting the surfaces with a first aqueous solution of a chelating agent, allowing the chelating agent to dissolve the metal scale, acidifying the solution to form a precipitant of the chelating agent and a precipitant of the metal from the metal scale, isolating the precipitant of the chelating agent and the precipitant of the metal from the first solution, selectively dissolving the precipitated chelating agent in a second aqueous solution, and removing the precipitated metal from the second solution is disclosed. This is understood to be a multi-step process which would cause longer shutdown in production and is not determined to actually be applicable in the field.

Despite the existing prior art, there are very few commercial compositions available to remove barium sulfate scale. There is thus a profound need for compositions capable of removing very difficult to remove sulfate scales present in oilfield operations.

### SUMMARY OF THE INVENTION

According to a first aspect of the present invention, there is provided an aqueous composition for use in removing sulfate scale from a surface contaminated with such, said composition comprising:
a chelating agent and a counterion component selected from the group consisting of: Li₅DTPA; Na₅DTPA; K₅DTPA; Cs₅DTPA; Na₄EDTA; K₄EDTA; TEAH₄DTPA; and TBAH₅DTPA; and
a scale removal enhancer

Preferably, the scale removal enhancer is selected from the group consisting of: potassium carbonate; potassium formate; cesium carbonate; cesium formate; and combinations thereof. Preferably also, the scale removal enhancer is present in the composition in an amount ranging from 5 to 20 wt % of the weight of the composition. More preferably, the scale removal enhancer is present in the composition in an amount ranging from 5 to 15 wt % of the weight of the composition. Even more preferably, the scale removal enhancer is present in the composition in an amount of approximately 5 to 10 wt % of the weight of the composition. Most preferably, the scale removal enhancer is present in the composition in an amount of approximately 5 wt % of the weight of the composition.

According to another aspect of the present invention, there is provided a method of removing sulfate scale, said method comprising the steps of:
providing a liquid composition comprising:
   a chelating agent selected from the group consisting of: Li₅DTPA; Na₅DTPA; K₅DTPA; Cs₅DTPA; Na₄EDTA; K₄EDTA; TEAH₄DTPA; and TBAH₅DTPA;
   optionally, a scale removal enhancer;
exposing a surface contaminated with barium sulfate scale to the liquid composition; allowing sufficient time of exposure to remove barium sulfate scale from the contaminated surface.

According to another aspect of the present invention, there is provided an aqueous composition for use in removing sulfate scale from a surface contaminated with such, said composition comprising:
a chelating agent and a counterion component selected from the group consisting of: Li₅DTPA; Na₅DTPA; K₅DTPA; K₅DTPA; Cs₅DTPA; Na₄EDTA; K₄EDTA; TEAH₄DTPA; and TBAH₅DTPA; and
a scale removal enhancer.

Preferably, the scale removal enhancer is selected from the group consisting of: potassium carbonate; potassium formate; cesium formate and cesium carbonate and combinations thereof. Preferably, the scale removal enhancer is present in the composition in an amount ranging from 5 to 20% wt of the weight of the composition. More preferably, from 10 to 15% wt of the weight of the composition. Also preferably, the scale removal enhancer is present in the composition in an amount of approximately 10% wt of the weight of the composition.

Preferably, the chelating agent and counterion are present in the composition in an amount ranging from 5 to 40% wt of the weight of the composition. More preferably, from 10 to 30% wt of the weight of the composition. Also preferably, the chelating agent and counterion are present in the composition in an amount ranging from 10 to 20% wt of the weight of the composition.

Preferably, the pH of the composition ranges from 10 to 11.

### BRIEF DESCRIPTION OF THE FIGURES

Features and advantages of embodiments of the present application will become apparent from the following detailed description and the appended figures, in which:

FIG. 1 is a picture showing the amount of scale produced in a tubing section when barium sulfate scale is left to accumulate;

FIG. 2 is a picture showing the barium sulfate scale crystals inside a tubing section;

FIG. 3 is a picture showing a close up of crystals removed from the tubing in FIG. 2;

FIG. 4 is a picture showing the experimental dissolution of crystals of barium sulfate scale over a period of time (at 0 hour; after 1 hour; and after 4 hours);

FIG. 5 is a graph depicting the temperature impact on the dissolution of barium sulfate scale.

### DETAILED DESCRIPTION OF A PREFERRED EMBODIMENT

According to a preferred embodiment of the present invention, the sulfate scale removing composition provides a safety advantage over known compositions. By the addition of potassium carbonate to the K₅DTPA, the same solubility numbers can be attained at a lower pH. Instead of 13.5 a pH of 11 was sufficient to get comparable solubility numbers. This represents a considerable difference and safety and environmental advantage.

According to a preferred embodiment of the present invention, the sulfate scale removing composition provides improved rates of scale dissolution. This, in turn, reduces the down time or non-producing time for wells or equipment where the scale is being removed or treated. It also reduces the cost of such treatment, by limiting the treatment time and bring revenue generation back on-line faster.

According to a preferred embodiment of the present invention, a composition for removing sulfate scale permits the removal thereof at a much lower pH than what has been practiced to date. Indeed, such a composition can effectively remove barium scale under conditions where the pH is approximately 11 (ranging from 10.5-11.5 and more preferably from 10.8 to 11.2), rather than other scale removal compositions which require conditions where the pH is 13 or higher. According to another preferred embodiment of the present invention, there is provided a composition where the pH is 10 and removes 30 kg/m³ of BaSO₄ scale.

According to a preferred embodiment of the present invention, a composition for removing barium sulfate scale permits the removal thereof with a higher dissolution capacity. This, in turn, allows reducing the volume of scale remover necessary. This also decreases transport costs and many other related items resulting from the usage of lower volumes of scale remover.

According to a preferred embodiment of the present invention, a composition for removing barium sulfate scale permits the removal thereof at substantially lower temperature than other barium sulfate scale removing treatments and with greater efficiency. This results in safer treatment conditions for individuals involved in this process.

### Absolute Solubility of Barium Sulfate Scale

The inventors have noted that chelating agents such as EDTA (Ethylenediaminetetraacetic acid) or DTPA (diethylenetriaminepentaacetic acid) and the ability to dissolve barium sulfate depends substantially on the size and ion strength of the counterion. EDTA is a very poor choice to dissolve barium sulfate scale. It has respectable ability to dissolve calcium sulfate scale but in the presence of barium sulfate it is almost ineffective. Hence, having a composition capable of dissolving both barium sulfate and calcium sulfate scale efficiently would be very desirable.

In Tables 1 and 2 (absolute solubility testing) the absolute (or maximum) solubility increases with the size of the counterion from lithium to cesium. TEAH (Tetraethylammonium hydroxide) and TBAH (Tetrabutylammonium hydroxide) as organic bases (counterions) are showing the same trend. Information indicates that the size of the TBAH cation (including the hydrate layer) is comparable to potassium.

The solubility numbers for both were found to be very similar. In order to quantitatively compare the kg/solubility properly, the BaSO₄:chelating agent ratio was calculated in g/mol and the Ba²⁺:chelating agent ratio was calculated in mol/mol. The mol:mol ratio indicates the number of molecules of the chelating agent needed to dissolve one ion of Ba²⁺ (complex). The highest ratio which was found was almost 0.5, which means that there needs to be, on average, 2 molecules of DTPA to dissolve 1 Ba²⁺ ion but mostly it can be much less.

Tests performed have indicated that, besides the nature of the counterion, an excess of the counterion also improves the solubility. K₅DTPA was tested in conjunction with KCl, K₂CO₃ and KOOCH (potassium formate). Interestingly, here the counterion plays also a large role as K₂CO₃ (with the larger anion) was much more effective than KCl (with a small anion).

TABLE 1
Absolute solubility of Barium Sulfate Scale (when using
a 40% solution of the scale removing composition)

| | | 40 wt % sol | | |
|---|---|---|---|---|
| | | BaSO4 | BaSO4 | Ba2⁺ |
| | pH | (kg/m3) | (g/mol) | (mol/mol) |
| Li₅DTPA | | 2 | | |
| Na5DTPA | 13.01 | 17 | 20.24 | 0.088 |
| K₅DTPA | 13.25 | 46 | 62.16 | 0.266 |
| K₅DTPA + 10 wt % K₂CO₃ | 13.21 | 38 | 51.35 | 0.22 |
| Cs5DTPA | 13.4 | 52 | 72.2 | 0.309 |
| Na₄EDTA | 13.11 | 9 | 7.89 | 0.034 |
| K₄EDTA | 13.32 | 31 | 32.98 | 0.141 |
| TEAH₄DTPA | 13.1 | 14 | 43.75 | 0.187 |
| TBAH₅DTPA | 13.33 | 18 | 64.28 | 0.275 |

TABLE 2
Absolute solubility of Barium Sulfate Scale (when using a
20% solution of the scale removing composition) at 60° C.

| | | 20 wt % sol | | |
|---|---|---|---|---|
| | | BaSO4 | BaSO4 | Ba2⁺ |
| | pH | (kg/m3) | (g/mol) | (mol/mol) |
| K₅DTPA | 13.19 | 27 | 72.97 | 0.313 |
| K₅DTPA + 5 wt % K₂CO₃ | 13.32 | 41 | 110.81 | 0.475 |
| K₅DTPA + 5 wt %K₂CO₃ | 11.25 | 40 | 108.11 | 0.463 |
| K₅DTPA + 5 wt % K₂CO₃ | 10 | 33 | 89.19 | 0.3821 |
| Cs5DTPA + 5 wt % CsCO3 | 11.1 | 35 | | |
| Cs5DTPA + 10 wt % CsCO₃ | 11.2 | 35 | | |
| Cs5DTPA + 10 wt % | 10.9 | 30 | | |
| HCOOCs | | | | |
| TEAH4DTPA + 10 wt % | 11 | 21 | | |
| K₂CO₃ | | | | |
| TBAH5DTPA + 10 wt % | 11.1 | 25 | | |
| K₂CO₃ | | | | |

Moreover, the K₅DTPA composition (at 40%) was determined to dissolve 30 kg/m³ of FeS for a g/mol total of 40.54.

Preferably, the dissolution of barium sulfate in an amount above 20 kg/m³. More preferably, dissolution of barium sulfate above 30 kg/m³ is desired.

### Speed of Barium Scale Dissolution

A second set of tests were performed to study the speed of the barium sulfate scale dissolution. In order to determine the speed, a relatively small amount of BaSO₄ (0.25 g—this equates to 2.5 kg/m³) was used and the time was measured until the solution became clear. Large differences were noted. The best results involved the combination of K₅DTPA with K₂CO₃. This combination provided a dissolution time which was almost 4 times faster than K₅DTPA alone.

The speed of dissolution of compositions according to preferred embodiment of the present invention were tested and studied. Table 3 summarizes the findings of the testing. The experiment involved the dissolution of 0.25 g of BaSO₄ in a volume of 100 ml fluid at 60° C. under gentle stirring by magnetic stir bar.

TABLE 3
Speed of Dissolution of Barium Sulfate Scale

| | | |
|---|---|---|
| Fluid | Time | pH |

| | | |
|---|---|---|
| K₅DTPA (40%) | 1 h 44 min | 13.26 |
| K₅DTPA (40%) + 10% TBAH | 1 h 38 min | 13.4 |
| K₅DTPA (40%) + 20% TBAH | 1 h 21 min | 13.43 |
| K₅DTPA (40%) + 30% TBAH | 1 h 20 min | 13.49 |
| K₅DTPA (40%) + 10 wt % KCl | 1 h 24 min | 13.27 |

| | | | |
|---|---|---|---|
| K₅DTPA (40%) + 10% K₂CO₃ | 30 | min | 13.22 |
| K₅DTPA (20%) + 5% K₂CO₃ | 22-23 | min | 10.5-11 |

This testing indicates that both the extent of barium scale dissolution and the speed at which it is dissolved represent marked improvements over known compositions.

Preferred compositions of the present invention further comprises a scale removal enhancer selected from the group consisting of: K₂CO₃; KOOCH; CsCO₃; CsCOOH and combinations thereof. Preferably, the scale removal enhancer is K₂CO₃. Preferably, the scale removal enhancer is present in an amount ranging from 5 to 30% by weight of the scale removal composition. More preferably from 5 to 20% by weight and even more preferably, the scale removal enhancer would be present in an amount of approximately 5-15 wt %, yet even more preferably from 5-10 wt % and most preferably in an amount of approximately 5 wt %.

### Impact of Temperature

The speed of dissolution of a composition according to preferred embodiment of the present invention was tested and studied under different temperature conditions. Table 4 summarizes the findings of the testing. The experiment involved the dissolution of 0.25 g of BaSO₄ (2.5 kg/m³) in a volume of 100 ml of fluid at various temperatures under gentle stirring by magnetic stir bar. The composition tested comprised a 20 wt % solution of K₅DTPA and 5 wt % K₂CO3.

TABLE 4
Impact of Temperature on the Dissolution of Barium Sulfate

| Temperature in | Time |
|---|---|
| ° C. (° F.) | (minutes) |
| 25 (77) | 225 |
| 40 (104) | 50 |
| 60 (140) | 22 |
| 80 (176) | 3.5 |
| 90 (194) | 1.5 |

Moreover, the compositions used are quite environmentally safe. This represents a major advantage over any known chemically-based methods of barium scale removal. Another advantage to the compositions according to preferred embodiments of the present invention includes the speed of dissolution which is considerably faster than any known commercial compositions. Another advantage of preferred compositions according to the present invention is that they can be deployed on wells according to a one-step process and thus are very desirable to operators which deal with barium sulfate scale issues often.

Compositions according to the preferred embodiment provide substantial improvement in sulfate scale removal starting 40° C. More preferably, the preferred compositions according to the present invention can be used at temperatures of at least 50° C., even more preferably at temperatures of at least 60° C. In some cases, the compositions according to preferred embodiments of the present invention can be exposed to temperatures of up to 80° C. and even up to 90° C. and higher and still provide excellent sulfate scale removal performance.

Compositions according to the present invention which exhibit a pH below 12 are considered non-regulated by Transport Canada, this provides a substantial advantage to any operator with respect to reduced transportation costs and related costs. According to a preferred embodiment of the present invention, water is the sole solvent used in the preparation and dilution of the composition. The preparation of a composition according to the present invention is carried out by exposing the various components to water and ensuring complete and proper dilution and obtaining an homogeneous solution.

Preferably, the aqueous composition according to the present invention have a pH ranging from 10.5 to 11.5. More preferably, the aqueous composition according to the present invention have a pH ranging from 10.8 to 11.2.

According to a preferred embodiment of the present invention, there is provided a one-step process for removing sulfate scale inside a wellbore, said process comprising:
providing a liquid composition comprising:
   a chelating agent selected from the group consisting of: Li₅DTPA; Na₅DTPA; K₅DTPA; K₅DTPA; Cs₅DTPA; Na₄EDTA; K₄EDTA; TEAH₄DTPA; and TBAH₅DTPA;
   optionally, a scale removal enhancer;
exposing a surface contaminated with barium sulfate scale to the liquid composition;
allowing sufficient time of exposure to remove barium sulfate scale from the contaminated surface. A person skilled in the art will understand that what is meant by “one-step” is that there is a single treatment step in the process (or method) to remove the sulfate scale buildup. Preferably, The sulfate scale is selected from the group consisting of: magnesium sulfate; barium sulfate; calcium sulfate; strontium sulfate; radium sulfate; and combinations thereof.

When the surface contaminated is deep underground or a hard to access tubing or piping, the exposure consists of circulating the liquid composition through the tubing or piping until it has been established that the scale has been removed beyond a desirable predetermined point. Hence, in some cases, it is quite possible that the entirety of the scale present is not removed but the amount of removal is sufficient to re-start operations and provide the desired productivity and/or circulation through the affected tubing/piping. The liquid composition can also be heated in order to improve the removal of the scale and the speed at which the removal is effected or heated naturally by geological heat.

According to another preferred embodiment of the present invention, the method of treatment of BaSO₄ scale wherein the fluid is «spotted», i.e placed in a tube/tank/pipe/equipment in a soaking operation. This may in some instances be somewhat less efficient than circulating the fluid due to the surface reaction nature of the fluid, but it is used in some cases to remove enough scale to run tools or reestablish circulation in an exchanger completely plugged off by scale, for example.

### Field Testing Results

An International E&P company operating in the WCSB utilizing downhole chokes on their wells has had ongoing issues with sulfate blockage. As production pressures declined the chokes need to be removed and it was found that barium sulfate (BaSO₄) scale deposition in the tubing was making the process very difficult, if at all possible to continue production. Various commercially available dissolvers were deployed with no effect. Mechanical solutions were inhibited by large scale tubing deposition resulting in stuck pipe.

A barium sulfate scale dissolver according to a preferred embodiment of the present invention (was deployed in an attempt to remove the scale deposits and retrieve by completely freeing the choke of scale. While the composition (K₅DTPA 20 wt % and 5 wt % K₂CO3) according to a preferred embodiment of the present invention would have been able to perform without agitation at low temperatures, in order to optimize its performance, agitation along with the elevated temperatures were employed to expedite dissolution. The wells in the field where the testing was carried out typically have BHT (bottom hole temperature) of −110° C.

A volume of approximately 500 gallons of a composition according to the present invention were delivered and loaded into a pressure truck. A wireline unit deployed a scraper brush into the wellbore and was used to create agitation around the scale as the composition was periodically spotted and left to soak. Over the next few hours the bottom hole agitator reached its target depth and once contact was established the choke, it was successfully retrieved.

Utilizing the composition according to the present invention along with agitation from the bottom hole agitator the operator was able to remove enough scale to retrieve the choke and recommence the production of the well. Utilizing the composition according to the present invention, the operator was able to solubilize over 80 kg of scale thus allowing the choke to be removed and sized accordingly to current flow rates and pressures. This highly effective product is capable of solubilizing more than twice as much barium sulfate scale than the leading competitions claimed rates, many of which failed prior to the deployment of the present invention

Moreover, the composition according to the preferred embodiment of the present invention showed no damage to wellbore metals and seals for the period of time for which they were employed which allows long soaks to be performed (+24 hr). With a high temperature stability of −130° C./270° F. and a lower pH profile than most dissolvers of pH 10.5 to 11, the composition according to a preferred embodiment of the present invention provides a substantially increased level of performance and safety to operations. Advantageously, the speed and efficiency of the scale dissolving agent were noted to be beyond anything that had ever been proposed to or deployed the operator.

### Laboratory Testing of Scale Dissolution

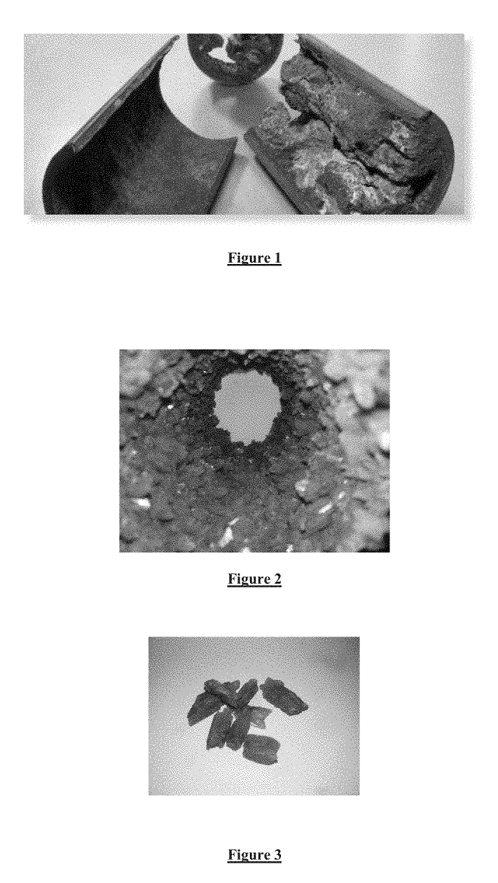

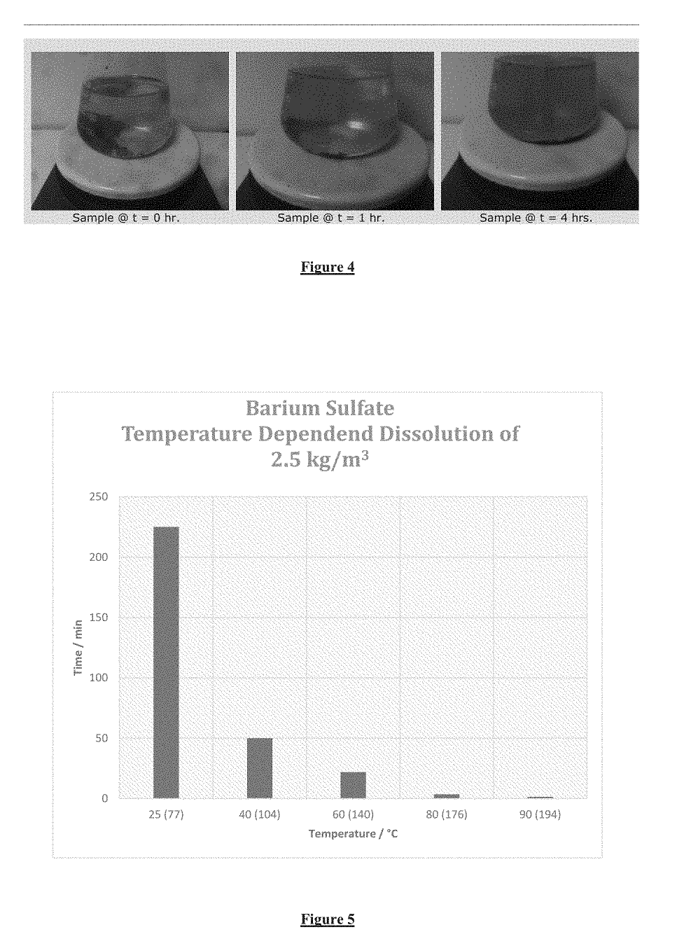

The sample selected for the solubility testing origins from an oilfield tubular containing sulfate scale crystals originally used for demonstration purposes. FIGS. 1 and 2 show the inside of an oilfield tubular containing sulphate scale similar to most deposits encountered.

Crystals of barium sulfate scale were removed from the tubular to be used for the solubility testing. 200 cc of composition (K₅DTPA 20 wt % and 5 wt % K₂CO3) was used. A weighted portion of oilfield sulphate scale sample was submerged in 200 cc of each de-scaling composition. A small magnetic stirrer is added to create a very minimal vortex, creating a small movement of fluid without rigorously stirring the fluid. The fluid was heated to 70° Celsius.

### Results

25.165 grams of oilfield sulphate scale was weighted and added to the fluid. The stirrer and heater were started. After 1 hour, a slight colouring of the fluid was observed. After 4 hours at temperature when no continued visual reduction of scale was observed, the fluid was filtered and the filter rinsed with water, dried and weighed. The maximum scale solubility was reached and subsequently calculated.

The composition according to a preferred embodiment of the present invention was able to dissolve 52.97 grams per litre of scale at 70° Celsius.

The testing was also carried out with a commercially available product (Barsol NS™), which is alkali/EDTA based and with EDTA. The Barsol NS™ product was capable of dissolving 24.19 grams per litre. EDTA attained a poor dissolution of only around 6 grams per litre. Under identical conditions, the composition according to a preferred embodiment of the present invention has shown to have more than double the performance of Barsol NS™.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A Method of removing sulfate scale off of a contaminated surface, said method comprising:
providing a liquid composition comprising:
a chelating agent selected from the group consisting of: Li₅DTPA; Na₅DTPA; K₅DTPA; Cs₅DTPA; Na₄EDTA; K₄EDTA; TEAH₄DTPA; and TBAH₅DTPA;
exposing said surface contaminated with barium sulfate scale to the liquid composition;
allowing sufficient time of exposure to remove barium sulfate scale from the contaminated surface.

2. The method according to claim 1, wherein the liquid composition further comprises a scale removal enhancer that is selected from the group consisting of: potassium carbonate; potassium formate; cesium formate; cesium carbonate; and combinations thereof.

3. The method according to claim 1, wherein the sulfate scale is selected from the group consisting of: magnesium sulfate; barium sulfate; calcium sulfate; strontium sulfate; radium sulfate; and combinations thereof.

4. An aqueous composition for use in removing sulfate scale from a surface contaminated with such, said composition comprising:
a chelating agent and a counterion component selected from the group consisting of: Li₅DTPA; Na₅DTPA; K₅DTPA; K₅DTPA; Cs₅DTPA; Na₄EDTA; K₄EDTA; TEAH₄DTPA; and TBAH₅DTPA; and
a scale removal enhancer.

5. The aqueous composition according to claim 4, wherein the scale removal enhancer is selected from the group consisting of: potassium carbonate; potassium formate; cesium formate and cesium carbonate and combinations thereof.

6. The aqueous composition according to claim 4, wherein the scale removal enhancer is present in the composition in an amount ranging from 5 to 20 wt % of the weight of the composition.

7. The aqueous composition according to claim 4, wherein the scale removal enhancer is present in the composition in an amount ranging from 5 to 15 wt % of the weight of the composition.

8. The aqueous composition according to claim 4, wherein the scale removal enhancer is present in the composition in an amount of approximately 5 to 10 wt % of the weight of the composition.

9. The aqueous composition according to claim 4, wherein the scale removal enhancer is present in the composition in an amount of approximately 5 wt % of the weight of the composition.

10. The aqueous composition according to claim 4, wherein the chelating agent and counterion are present in the composition in an amount ranging from 5 to 40% wt of the weight of the composition.

11. The aqueous composition according to claim 4, wherein the chelating agent and counterion are present in the composition in an amount ranging from 10 to 30% wt of the weight of the composition.

12. The aqueous composition according to claim 4, wherein the chelating agent and counterion are present in the composition in an amount ranging from 10 to 20% wt of the weight of the composition.

13. The aqueous composition according to claim 4, wherein the pH of the composition ranges from 10.5 to 11.5.

14. The aqueous composition according to claim 4, wherein the pH of the composition ranges from 10.8 to 11.2.

15. The aqueous composition according to claim 4, wherein the sulfate scale is selected from the group consisting of: magnesium sulfate; barium sulfate; calcium sulfate; strontium sulfate; radium sulfate; and combinations thereof.

16. The aqueous composition according to claim 4, wherein the sulfate scale is barium sulfate.

17. The aqueous composition according to claim 4, wherein the sulfate scale is radium sulfate.
